(19) United States
(12) Patent Application Publication
(10) Pub. No.: US 2025/0344114 A1
(43) Pub. Date: Nov. 6, 2025

(54) METHOD FOR TRANSMITTING CONFIGURATION INFORMATION, ELECTRONIC DEVICE, AND READABLE STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/871,756

(22) PCT Filed: Jun. 7, 2022
(86) PCT No.: PCT/CN2022/097354

§ 371 Date: Dec. 4, 2024

(51) Int. Cl. H04W 36/00; H04L 5/00

(52) U.S. Cl. CPC H04W 36/00692; H04L 5/0098

(57) ABSTRACT

A method for receiving configuration information, including: receiving a first configuration message for indicating a carrier aggregation type, where the carrier aggregation type is intra-band contiguous carrier aggregation or intra-band non-contiguous carrier aggregation; and determining an additional spectrum emission mode corresponding to the carrier aggregation type.

### CROSS-REFERENCE TO RELATED APPLICATION

The present application is a U.S. National Stage of International Application No. PCT/CN2022/097354, filed on Jun. 7, 2022, the contents of all of which are incorporated herein by reference in their entireties for all purposes.

### BACKGROUND OF THE INVENTION

Different regions have different additional demands for spectrum emissions for wireless communications. In wireless communication systems such as a 3GPP long term evolution (LTE) system or a 5G new radio (NR) system, a base station may indicate spectrum emission requirements which need to be met by a mobile terminal in different frequency bands in a case of a single carrier.

### SUMMARY OF THE INVENTION

The disclosure relates to the field of wireless communications, in particular to a method and apparatus for transmitting configuration information, and a readable storage medium.

In a first aspect, there is provided a method for receiving configuration information. The method for receiving the configuration information is performed by a mobile terminal, and includes: receiving a first configuration message for indicating a carrier aggregation type, where the carrier aggregation type is intra-band contiguous carrier aggregation or intra-band non-contiguous carrier aggregation; and determining an additional spectrum emission mode corresponding to the carrier aggregation type.

In a second aspect, there is provided a method for sending configuration information. The method for sending configuration information is performed by a network device, and includes: sending, to a mobile terminal, a first configuration message for indicating a carrier aggregation type. The carrier aggregation type is intra-band contiguous carrier aggregation or intra-band non-contiguous carrier aggregation.

In a third aspect, there is provided an apparatus for receiving configuration information. The apparatus for receiving the configuration information may be configured to perform steps performed by a mobile terminal in the first aspect or in any of designs of the first aspect. Each function in each of the methods may be implemented by the mobile terminal in a form of a hardware structure, a software module, or a hardware structure plus a software module.

In a case that the apparatus in the third aspect is implemented by means of the software module, the apparatus may include a transceiving module and a processing module coupled to each other, where the transceiving module may be configured to support a communication apparatus for a communication, and the processing module may be configured to support the communication apparatus for executing a processing operation such as generating information/message that needs to be sent, or processing a received signal to obtain information/message.

When executing the steps in the first aspect, the transceiving module is configured to receive a first configuration message configured to indicate a carrier aggregation type, where the carrier aggregation type is intra-band contiguous carrier aggregation or intra-band non-contiguous carrier aggregation; and the processing module is configured to determine an additional spectrum emission mode corresponding to the carrier aggregation type.

In a fourth aspect, there is provided an apparatus for sending configuration information. The apparatus for sending the configuration information may be configured to execute steps executed by a network device in the second aspect or in any of designs of the second aspect. Each function in each of the methods may be implemented by the network device in a form of a hardware structure, a software module, or a hardware structure plus a software module.

In a case that the apparatus in the fourth aspect is implemented by means of the software module, the apparatus may include a transceiving module, where the transceiving module may be configured to support a communication apparatus for a communication.

When executing the steps in the second aspect, the transceiving module is configured to send to a mobile terminal a first configuration message for indicating a carrier aggregation type. The carrier aggregation type is intra-band contiguous carrier aggregation or intra-band non-contiguous carrier aggregation.

In a fifth aspect, there is provided an electronic device, including a processor and a memory. The memory is configured to store a computer program. The processor is configured to execute the computer program to implement the first aspect or any of designs of the first aspect.

In a sixth aspect, there is provided an electronic device, including a processor and a memory. The memory is configured to store a computer program. The processor is configured to execute the computer program to implement the second aspect or any of designs of the second aspect.

In a seventh aspect, there is provided a non-transitory computer readable storage medium. An instruction (or called a computer program or a program) is stored in the non-transitory computer readable storage medium, and the instruction, when being called and executed on a computer, causes the computer to execute the first aspect or any of designs of the first aspect.

In an eighth aspect, there is provided a non-transitory computer readable storage medium. An instruction (or called a computer program or a program) is stored in the non-transitory computer readable storage medium, and the instruction, when being called and executed on a computer, causes the computer to execute the second aspect or any of designs of the second aspect.

### BRIEF DESCRIPTION OF DRAWINGS

Accompanying drawings illustrated are used for providing a further understanding of examples of the disclosure and constitute a part of the disclosure. Schematic examples of the disclosure and their descriptions are used for explaining the examples of the disclosure and do not constitute an improper limitation of the examples of the disclosure. In the accompanying drawings:

the accompanying drawings are incorporated into the specification and constitute a part of the specification, show the examples consistent with the examples of the disclosure, and together with the specification, are used for explaining the principle of the examples of the disclosure.

FIG. 1 is a schematic architecture diagram of a wireless communication system according to an example of the disclosure.

FIG. 2 is a flowchart of a method for transmitting configuration information according to an example of the disclosure.

FIG. 3 is a flowchart of a method for receiving configuration information according to an example of the disclosure.

FIG. 4 is a flowchart of another method for receiving configuration information according to an example of the disclosure.

FIG. 4A is a flowchart of another method for receiving configuration information according to an example of the disclosure.

FIG. 5 is a flowchart of another method for receiving configuration information according to an example of the disclosure.

FIG. 6 is a flowchart of another method for receiving configuration information according to an example of the disclosure.

FIG. 6A is a flowchart of another method for receiving configuration information according to an example of the disclosure.

FIG. 6B is a flowchart of another method for receiving configuration information according to an example of the disclosure.

FIG. 6C is a flowchart of another method for receiving configuration information according to an example of the disclosure.

FIG. 7 is a schematic diagram of mapping of additionalSpectrumEmission parameters to frequency bands according to an example of the disclosure.

FIG. 8 is a schematic diagram of mapping of additionalSpectrumEmission parameters to frequency bands according to another example of the disclosure.

FIG. 9 is a flowchart of a method for sending configuration information according to an example of the disclosure.

FIG. 9A is a flowchart of a method for sending configuration information according to an example of the disclosure.

FIG. 9B is a flowchart of a method for sending configuration information according to an example of the disclosure.

FIG. 9C is a flowchart of a method for sending configuration information according to an example of the disclosure.

FIG. 9D is a flowchart of a method for sending configuration information according to an example of the disclosure.

FIG. 9E is a flowchart of a method for sending configuration information according to an example of the disclosure.

FIG. 10 is a block diagram of an apparatus for receiving configuration information according to an example of the disclosure.

FIG. 11 is a block diagram of a mobile terminal according to an example of the disclosure.

FIG. 12 is a block diagram of an apparatus for sending configuration information according to an example of the disclosure.

FIG. 13 is a block diagram of a communication apparatus according to an example of the disclosure.

### DETAILED DESCRIPTION OF THE INVENTION

Examples of the disclosure are further illustrated in conjunction with accompanying drawings and implementations.

Examples will be illustrated in detail, and their instances are shown in the accompanying drawings. When the following description refers to the accompanying drawings, unless otherwise indicated, the same numbers in different accompanying drawings indicate the same or similar elements. Implementations described in the following examples do not represent all implementations consistent with the examples of the disclosure. Rather, they are instances of apparatuses and methods consistent with some aspects of the disclosure as detailed in the appended claims.

Terms used in the examples of the disclosure are for the purpose of describing examples, and are not intended to limit the examples of the disclosure. Singular forms “one” and “the” used in the examples of the disclosure and the appended claims are also intended to include plural forms unless the context clearly indicates other meanings. It is also to be understood that a term “and/or” as used refers to and contains any or all possible combinations of one or more associated listed items.

It is to be understood that although terms first, second, third, etc. may be used for describing various information in the examples of the disclosure, such information is not to be limited to these terms. These terms are used for distinguishing the same type of information from each other. For example, without departing from the scope of the examples of the disclosure, first information may also be referred to as second information, and similarly, the second information may also be referred to as the first information. Depending on the context, for example, words “in case of” and “if” as used may be interpreted as “at the time” or “when” or “in response to determining”.

Examples of the disclosure are described in detail below, and instances of the examples are shown in accompanying drawings, where the same or similar reference numerals represent the same or similar elements all the time. The examples described below by reference to the accompanying drawings are examples, are intended to explain the disclosure, and cannot be construed as a limitation of the disclosure.

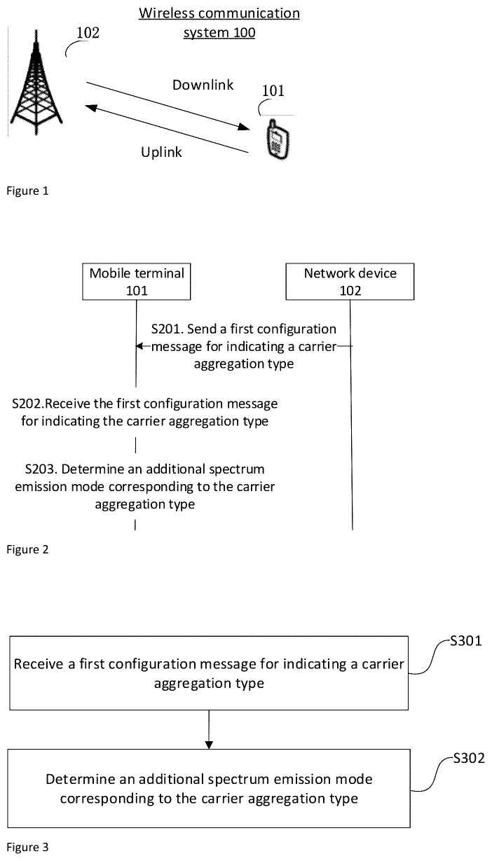

As shown in FIG. 1, a method for transmitting configuration information according to an example of the disclosure may be applied to a wireless communication system 100. The wireless communication system 100 may include a mobile terminal 101 and a network device 102. The mobile terminal 101 is configured to support carrier aggregation and may be connected to a plurality of carrier units of the network device 102. The plurality of carrier units may include one primary carrier unit and one or more secondary carrier units.

It is to be understood that the wireless communication system 100 may be applied to both a scenario of low-frequency and a scenario of high-frequency. Application scenarios for the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, or a future evolved public land mobile network (PLMN) system, etc.

The mobile terminal 101 may be user equipment (UE), a terminal, an access terminal, a terminal unit, a terminal station, a mobile station (MS), a remote station, a remote terminal, a mobile terminal, a wireless communication device, a terminal agent or a terminal device, etc. The mobile terminal 101 may have a wireless transceiving function, and can communicate (e.g., wirelessly communicate) with one or more network devices of one or more communication systems and receive a network service provided by the network device. The network device includes, but is not limited to, the illustrated network device 102.

The mobile terminal 101 may be a cellular telephone, a cordless telephone, a session initiation protocol (SIP) telephone, a wireless local loop (WLL) station, a personal digital assistant (PDA) device, a handheld device with a wireless communication function, a computing device or other processing devices connected to a wireless modem, an in-vehicle device, a wearable device, a terminal device in a future 5G network, or a terminal device in a future evolved PLMN, etc.

The network device 102 may be an access network device (or called an access network site). The access network device refers to a device that has a function of providing network access, such as a radio access network (RAN) base station, etc. The network device 102 may include a base station (BS), or include a base station and a radio resource management device for controlling the base station, etc. The network device 102 may also include a relay station (a relay device), an access point, and a base station in a future 5G network, a base station in a future evolved PLMN, or an NR base station, etc. The network device 102 may be a wearable device or an in-vehicle device. The network device 102 may also be a communication chip that has a communication module.

For example, the network device 102 includes, but is not limited to: a next generation base station (gnodeB, gNB) in 5G, an evolved node B (eNB) in an LTE system, a radio network controller (RNC), a node B (NB) in a WCDMA system, a wireless controller under a CRAN system, a basestation controller (BSC), a base transceiver station (BTS) in a GSM system or CDMA system, a home base station (e.g., a home evolved node B or a home node B (HNB)), a baseband unit (BBU), a transmitting and receiving point (TRP), a transmitting point (TP), or a mobile switching center, etc.

In a 4G LTE or 5G NR system, a parameter value of an additionalSpectrumEmission parameter and a frequency band number in a scenario of single carrier may be configured for the mobile terminal 101 by the network device 102 on the basis of a mapping relationship as shown in Table 1 below, so as to indicate a spectrum emission requirement which needs to be met by the mobile terminal in a set frequency band under a single carrier. However, a problem of how to determine a spectrum emission requirement for carrier aggregation (CA) needs to be solved.

TABLE 1

| NR fre- | | | | | | | | |
|---|---|---|---|---|---|---|---|---|
| quency | Value of additionalSpectrumEmission parameter | | | | | | | |
| band | 0 | 1 | 2 | 3 | 4 | 5 | 6 | 7 |
| n1 | NS_01 | NS_100 | NS_05 | NS_05U | NS_48 | NS_49 | | |
| n2 | NS_01 | NS_100 | NS_03 | NS_03U | | | | |
| n3 | NS_01 | NS_100 | | | | | | |
| n5 | NS_01 | NS_100 | | | | | | |
| n7 | NS_01 | NS_46 | | | | | | |
| n8 | NS_01 | NS_100 | NS_43 | NS_43U | | | | |
| n12 | NS_01 | NS_06 | | | | | | |
| n14 | NS_01 | NS_06 | | | | | | |
| n18 | NS_01 | NS_100 | | | | | | |
| n20 | NS_01 | Void | NS_10 | | | | | |
| n25 | NS_01 | NS_100 | NS_03 | NS_03U | | | | |
| n26 | NS_01 | NS_100 | NS_12 | NS_13 | NS_14 | NS_15 | | |
| n28 | NS_01 | NS_17 | NS_18 | | | | | |
| n30 | NS_01 | NS_21 | | | | | | |
| n34 | NS_01 | | | | | | | |
| n38 | NS_01 | NS_44 | | | | | | |
| n39 | NS_01 | NS_50 | | | | | | |
| n40 | NS_01 | | | | | | | |
| n41 | NS_01 | NS_04 | NS_47 | | | | | |
| n48 | NS_01 | NS_27 | | | | | | |
| n50 | NS_01 | NS_41 | NS_42 | | | | | |
| n51 | NS_01 | NS_40 | | | | | | |
| n53 | NS_01 | NS_45 | | | | | | |
| n65 | NS_01 | NS_24 | NS_100 | NS_05 | NS_05U | NS_51 | | |
| n66 | NS_01 | NS_100 | NS_03 | NS_03U | | | | |
| n70 | NS_01 | NS_03 | | | | | | |
| n71 | NS_01 | NS_35 | | | | | | |
| n74 | NS_01 | NS_37 | NS_38 | NS_39 | | | | |
| n77 | NS_01 | NS_55 | | | | | | |
| n78 | NS_01 | | | | | | | |
| n79 | NS_01 | | | | | | | |
| n80 | NS_01 | NS_100 | | | | | | |
| n81 | NS_01 | NS_100 | NS_43 | NS_43U | | | | |
| n82 | NS_01 | Void | NS_10 | | | | | |
| n83 | NS_01 | NS_17 | NS_18 | | | | | |
| n84 | NS_01 | NS_100 | NS_05 | NS_05U | | | | |
| n86 | NS_01 | NS_100 | NS_03 | NS_03U | | | | |
| n89 | NS_01 | NS_100 | | | | | | |
| n91 | NS_01 | | | | | | | |
| n92 | NS_01 | | | | | | | |
| n93 | NS_01 | | | | | | | |
| n94 | NS_01 | | | | | | | |
| n95 | NS_01 | | | | | | | |

There is provided a method for transmitting configuration information according to an example of the disclosure. Referring to FIG. 2, FIG. 2 is a method for transmitting configuration information according to an example. As shown in FIG. 2, the method for transmitting the configuration information includes steps S201, S202 and S203.

Step S201 includes sending to a mobile terminal 101 by a network device 102 a first configuration message for indicating a carrier aggregation type. The carrier aggregation type is intra-band contiguous carrier aggregation or intra-band non-contiguous carrier aggregation.

Step S202 includes receiving by the mobile terminal 101 the first configuration message for indicating the carrier aggregation type. The carrier aggregation type is the intra-band contiguous carrier aggregation or the intra-band non-contiguous carrier aggregation.

Step S203 includes determining by the mobile terminal 101 an additional spectrum emission mode corresponding to the carrier aggregation type.

In some examples, in the intra-band contiguous carrier aggregation, a plurality of component carriers (CCs) within a set frequency band are adjacent to each other. In the intra-band non-contiguous carrier aggregation, a set bandwidth is spaced between different CCs.

In some examples, the first configuration message is radio resource control (RRC) signaling.

In some examples, the additional spectrum emission mode corresponding to the carrier aggregation type is determined by the mobile terminal 101 according to an indication of the network device 102.

In some examples, the mobile terminal 101 may determine that a default mode is adopted for the additional spectrum emission mode in a scenario of carrier aggregation.

In some examples, according to the first configuration message, the mobile terminal 101 may be switched from a single-carrier data transmission mode to a data transmission mode for the intra-band contiguous carrier aggregation or the intra-band non-contiguous carrier aggregation of the CA.

In an example, before the first configuration message is sent, a frequency band and an additionalSpectrumEmission parameter under a single carrier may be configured for the mobile terminal 101 by the network device 102.

In some examples, an end of data transmission in the scenario of the CA may be determined by the mobile terminal 101 according to signaling sent by the network device 102. The mobile terminal 101 may be switched back to the single carrier for data transmission.

In the examples of the disclosure, the carrier aggregation type may be configured for the mobile terminal 101 by the network device 102. After obtaining the carrier aggregation type, the mobile terminal 101 may determine the additional spectrum emission mode corresponding to the carrier aggregation type. Thus, the mobile terminal 101 can determine an additional spectrum emission requirement which needs to be met in a corresponding frequency band in the scenario of the carrier aggregation, so as to perform signal transmission on the basis of the additional spectrum emission mode. In this way, not only the additional spectrum emission requirement under the single carrier, but also the additional spectrum emission requirement in the scenario of the carrier aggregation can be met.

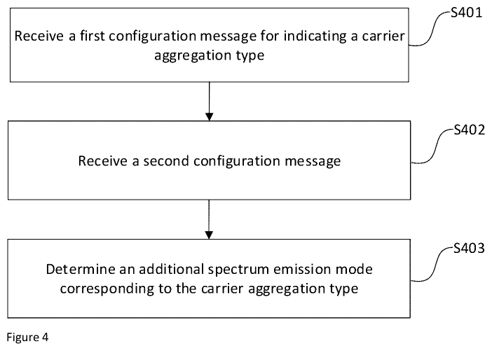

There is provided a method for receiving configuration information according to an example of the disclosure. Referring to FIG. 3, FIG. 3 is a method for receiving configuration information according to an example. The method for receiving the configuration information is performed by a mobile terminal 101. As shown in FIG. 3, the method for receiving the configuration information includes steps S301 and S302.

Step S301 includes receiving by the mobile terminal 101 a first configuration message for indicating a carrier aggregation type. The carrier aggregation type is intra-band contiguous carrier aggregation or intra-band non-contiguous carrier aggregation.

Step S302 includes determining by the mobile terminal 101 an additional spectrum emission mode corresponding to the carrier aggregation type.

In some examples, the additional spectrum emission mode corresponding to the carrier aggregation type is determined by the mobile terminal 101 according to a configuration of a network device 102. For example, according to a second configuration message received after the first configuration message, an additional spectrum emission mode indicated by an additionalSpectrumEmission parameter in the second configuration message is determined as the additional spectrum emission mode corresponding to the carrier aggregation type.

In some examples, the additional spectrum emission mode corresponding to the carrier aggregation type is determined by the mobile terminal 101 according to a configuration of the network device 102. For example, according to a third configuration message received before or after the first configuration message, the additional spectrum emission mode corresponding to the carrier aggregation type is determined by determining an additionalSpectrumEmission parameter corresponding to a carrier aggregation type indicated in the third configuration message.

In some examples, the mobile terminal 101 determines that a default mode is adopted for the additional spectrum emission mode in a scenario of carrier aggregation.

In the examples of the disclosure, after determining the carrier aggregation type according to the first configuration message, the mobile terminal 101 may determine the additional spectrum emission mode corresponding to the carrier aggregation type. Thus, the mobile terminal 101 can determine an additional spectrum emission requirement which needs to be met in a corresponding frequency band in the scenario of the carrier aggregation, so as to perform signal transmission on the basis of the additional spectrum emission mode. In this way, not only an additional spectrum emission requirement under a single carrier, but also an additional spectrum emission requirement in the scenario of the carrier aggregation can be met.

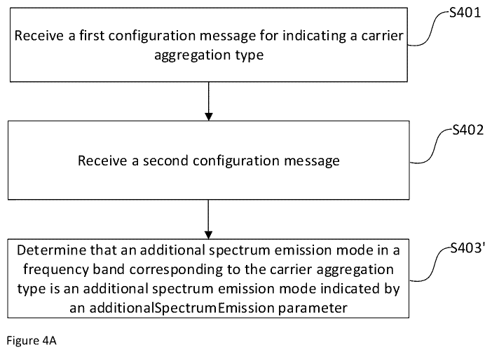

There is provided a method for receiving configuration information according to an example of the disclosure. Referring to FIG. 4, FIG. 4 is a method for receiving configuration information according to an example. The method for receiving the configuration information is performed by a mobile terminal 101. As shown in FIG. 4, the method for receiving the configuration information includes steps S401, S402, and S403.

Step S401 includes receiving by a mobile terminal 101 a first configuration message for indicating a carrier aggregation type is. The carrier aggregation type is intra-band contiguous carrier aggregation or intra-band non-contiguous carrier aggregation.

Step S402 includes receiving by the mobile terminal 101 a second configuration message. The second configuration message includes a frequency band parameter and an additionalSpectrumEmission parameter. The frequency band parameter is configured to indicate an identification of a frequency band. The additionalSpectrumEmission parameter is configured to indicate an identification of an additional spectrum emission mode in the frequency band.

Step S403 includes determining by the mobile terminal 101 an additional spectrum emission mode corresponding to the carrier aggregation type.

In some examples, radio resource control (RRC) signaling of a network device 102 is received by the mobile terminal 101, and the RRC signaling includes the second configuration message.

In some examples, the identification of the frequency band indicated by the frequency band parameter in the second configuration message corresponds to a frequency band under the carrier aggregation (CAband).

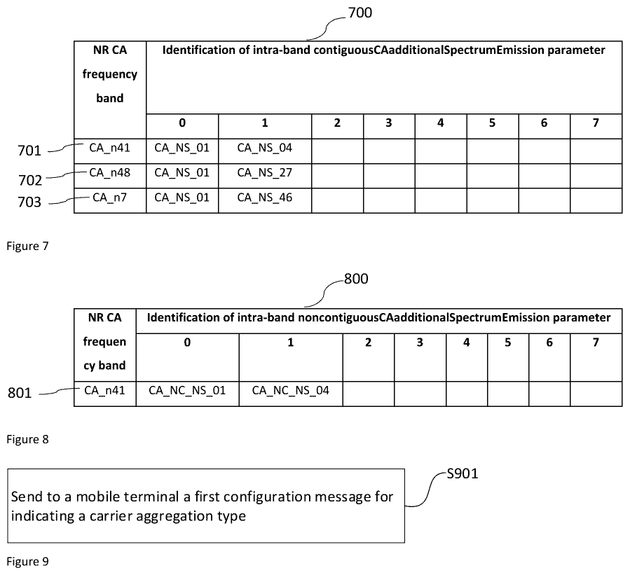

In an example, referring to Table 700 in FIG. 7, the identification of the frequency band may correspond to an n41 frequency band 701, an n48 frequency band 702, or an n7 frequency band 703 of the intra-band contiguous carrier aggregation.

In an example, referring to Table 800 in FIG. 8, the identification of the frequency band may correspond to an n41 frequency band 801 of the intra-band non-contiguous carrier aggregation.

In some examples, in the additionalSpectrumEmission parameter, the identification of the additional spectrum emission mode indicated by the additionalSpectrumEmission parameter may be represented by a value between 0 and 7, and each value corresponds to a network signaling (NS) value. A signal may be transmitted by the mobile terminal 101 in a frequency band of the intra-band contiguous carrier aggregation or the intra-band non-contiguous carrier aggregation according to a requirement of the NS value.

In some examples, the NS value corresponds to an additional maximum power reduction (A-MPR), and is configured to determine uplink transmission power of the mobile terminal 101 in the corresponding frequency band. The mobile terminal 101 reduces maximum transmission power according to the NS value to reduce interference.

In an example, referring to FIG. 7, the second configuration message includes a frequency band parameter and an additionalSpectrumEmission parameter. An identification of a frequency band indicated by the frequency band parameter corresponds to the n41 frequency band 701 of the intra-band contiguous carrier aggregation. An identification of an additional spectrum emission mode indicated by the additionalSpectrumEmission parameter is 1, and a corresponding NS value is NS_04. In this example, the mobile terminal 101 may determine, according to the second configuration message, to perform signal transmission in the n41 frequency band of the intra-band contiguous carrier aggregation according to a transmission requirement of the NS value.

In an example, referring to FIG. 8, the second configuration message includes a frequency band parameter and an additionalSpectrumEmission parameter. An identification of a frequency band indicated by the frequency band parameter corresponds to the n41 frequency band 801 of the intra-band non-contiguous carrier aggregation. An identification of an additional spectrum emission mode indicated by the additionalSpectrumEmission parameter is 0, and a corresponding NS value is NS_01. In this example, the mobile terminal 101 may determine, according to the second configuration message, to perform signal transmission in the n41 frequency band of the intra-band non-contiguous carrier aggregation according to a transmission requirement of the NS value.

In the examples of the disclosure, the network device 102 configures the second configuration message under the CA for the mobile terminal 101 after configuring the CA type for the mobile terminal, so that the mobile terminal 101 can learn that the second configuration message is an additional spectrum emission requirement corresponding to the configured carrier aggregation type.

There is provided a method for receiving configuration information according to an example of the disclosure. The method for receiving the configuration information is performed by a mobile terminal 101. The method for receiving the configuration information is shown in FIG. 4A and includes steps S401, S402 and S403′.

Step S401 includes receiving by the mobile terminal 101 a first configuration message for indicating a carrier aggregation type. The carrier aggregation type is intra-band contiguous carrier aggregation or intra-band non-contiguous carrier aggregation.

Step S402 includes receiving by the mobile terminal 101 a second configuration message. The second configuration message includes a frequency band parameter and an additionalSpectrumEmission parameter. The frequency band parameter is configured to indicate an identification of a frequency band. The additionalSpectrumEmission parameter is configured to indicate an identification of an additional spectrum emission mode in the frequency band.

Step S403′ includes the mobile terminal 101 determining that an additional spectrum emission mode in a frequency band corresponding to the carrier aggregation type is the additional spectrum emission mode indicated by the additionalSpectrumEmission parameter.

In some examples, a specific frequency band under the intra-band contiguous carrier aggregation or the intra-band non-contiguous carrier aggregation is determined by the mobile terminal 101 according to the identification of the frequency band.

In some examples, the mobile terminal 101 determines a corresponding NS value according to the identification of the additional spectrum emission mode, and thus transmits a signal according to an additional spectrum emission requirement characterized by this NS value.

In the examples of the disclosure, the mobile terminal 101 can determine the additional spectrum emission mode corresponding to the carrier aggregation type according to the second configuration message of the network device 102, and can thus transmit the signal according to the requirement of the additional spectrum emission mode.

In an example, the mobile terminal 101 accesses a network using a single carrier, a second configuration message is sent to the mobile terminal 101 by the network device 102. The second configuration message includes a frequency band parameter and an additionalSpectrumEmission parameter. An additional spectrum emission requirement under the single carrier may then be determined by the mobile terminal 101 according to the frequency band parameter and the additionalSpectrumEmission parameter in the second configuration message. In a case that the mobile terminal 101 needs to use the carrier aggregation, a first configuration message for indicating a carrier aggregation type is sent to the mobile terminal 101 by the network device 102, and the carrier aggregation type is determined by the mobile terminal 101 according to the first configuration message. A second configuration message is sent to the mobile terminal 101 again by the network device 102, this second configuration message includes a frequency band parameter and an additionalSpectrumEmission parameter, and an additional spectrum emission requirement under the carrier aggregation type may then be determined by the mobile terminal 101 according to the frequency band parameter and the additionalSpectrumEmission parameter in this second configuration message.

There is provided a method for receiving configuration information according to an example of the disclosure. Referring to FIG. 5, FIG. 5 is a method for receiving configuration information according to an example. The method for receiving the configuration information is performed by a mobile terminal 101. As shown in FIG. 5, the method for receiving the configuration information includes steps S501, S502 and S503.

Step S501 includes receiving by the mobile terminal 101 a first configuration message for indicating a carrier aggregation type. The carrier aggregation type is intra-band contiguous carrier aggregation or intra-band non-contiguous carrier aggregation.

Step S502 includes that a second configuration message is not received by the mobile terminal 101 after receiving the first configuration message, and the mobile terminal 101 determines that an identification of an additional spectrum emission mode corresponding to a set frequency band is a default value. The second configuration message includes a frequency band parameter and an additionalSpectrumEmission parameter, the frequency band parameter is configured to indicate an identification of a frequency band, and the additionalSpectrumEmission parameter is configured to indicate an identification of an additional spectrum emission mode corresponding to the frequency band.

Step S503 includes determining by the mobile terminal 101 an additional spectrum emission mode corresponding to the carrier aggregation type.

In some examples, the set frequency band is applicable to any frequency band in the intra-band contiguous carrier aggregation or the intra-band non-contiguous carrier aggregation.

In an example, referring to FIG. 7, the set frequency band may correspond to an n41 frequency band, an n48 frequency band, or an n7 frequency band of the intra-band contiguous carrier aggregation.

In an example, referring to FIG. 8, the set frequency band may correspond to an n41 frequency band of the intra-band non-contiguous carrier aggregation.

In some examples, the mobile terminal 101 may determine that the additional spectrum emission mode corresponding to the carrier aggregation type is an emission mode when the identification of the additional spectrum emission mode is a default value.

In an example, the default value is 0. In conjunction with FIG. 7, the NS value is NS_01 in a case that the carrier aggregation type is the intra-band contiguous carrier aggregation and the identification of the additional spectrum emission mode is 0.

In an example, the default value is 0. In conjunction with FIG. 8, the NS value is NS_01 in a case that the carrier aggregation type is the intra-band non-contiguous carrier aggregation and the identification of the additional spectrum emission mode is 0.

In the example of the disclosure, in a case that the second configuration message configured by the network device 102 for a scenario of the CA is not received by the mobile terminal 101, the mobile terminal 101 may assign a default value to the additionalSpectrumEmission parameter, and adopt a mode corresponding to the default value as the additional spectrum emission mode corresponding to the carrier aggregation type.

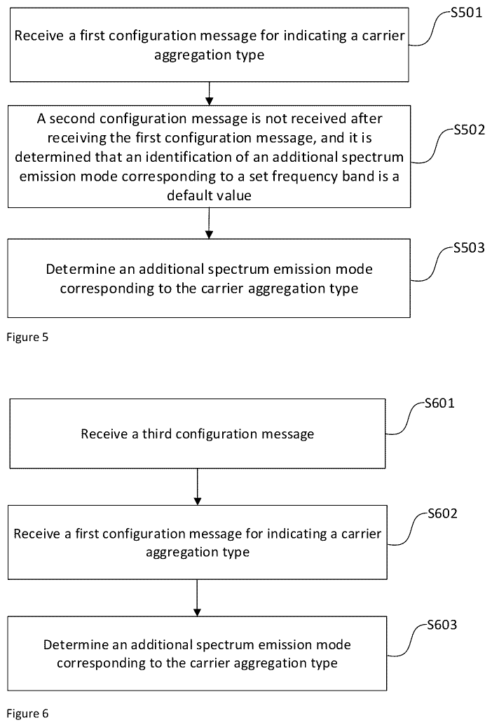

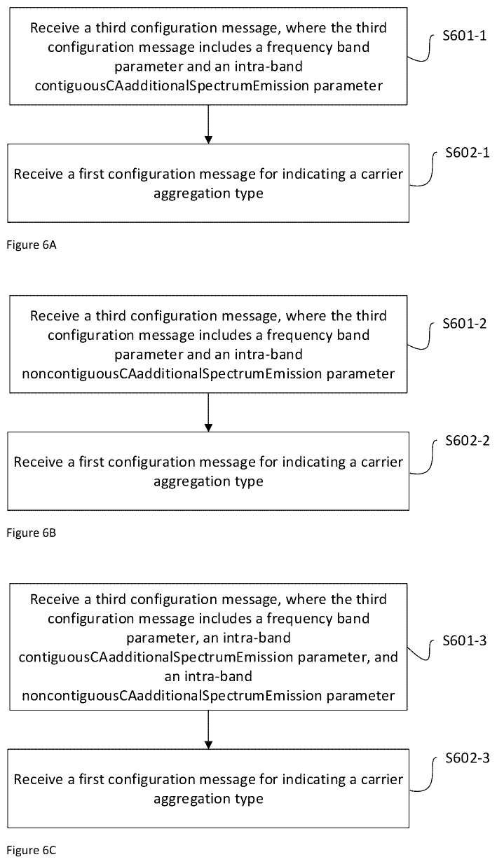

There is provided a method for receiving configuration information according to an example of the disclosure. Referring to FIG. 6, FIG. 6 is a method for receiving configuration information according to an example. The method for receiving the configuration information is performed by a mobile terminal 101. As shown in FIG. 6, the method for receiving the configuration information includes steps S601, S602 and S603.

Step S601 includes receiving by the mobile terminal 101 a third configuration message. The third configuration message includes a frequency band parameter and further includes at least one of an intra-band contiguousCAadditionalSpectrumEmission parameter and an intra-band noncontiguousCAadditionalSpectrumEmission parameter. The frequency band parameter is configured to indicate an identification of a frequency band. The intra-band contiguousCAadditionalSpectrumEmission parameter is configured to indicate, for transmission using the intra-band contiguous carrier aggregation by the mobile terminal, an identification of an additional spectrum emission mode in the frequency band. The intra-band noncontiguousCAadditionalSpectrumEmission parameter is configured to indicate, for transmission using the intra-band non-contiguous carrier aggregation by the mobile terminal, an identification of an additional spectrum emission mode in the frequency band.

Step S602 includes receiving by the mobile terminal 101 a first configuration message for indicating a carrier aggregation type. The carrier aggregation type is intra-band contiguous carrier aggregation or intra-band non-contiguous carrier aggregation.

Step S603 includes determining by the mobile terminal 101 an additional spectrum emission mode corresponding to the carrier aggregation type.

In some examples, the intra-band contiguousCAadditionalSpectrumEmission parameter is carried in the third configuration message configured for the mobile terminal 101 by the network device 102. A spectrum emission requirement which needs to be met in a case of performing transmission using the intra-band contiguous carrier aggregation is indicated by the intra-band contiguousCAadditionalSpectrumEmission parameter, e.g., the identification of the additional spectrum emission mode is indicated and corresponds to an NS value.

In some examples, the intra-band noncontiguousCAadditionalSpectrumEmission parameter is carried in the third configuration message configured for the mobile terminal 101 by the network device 102. A spectrum emission requirement which needs to be met in a case of performing transmission using the intra-band non-contiguous carrier aggregation is indicated by the intra-band noncontiguousCAadditionalSpectrumEmission parameter, e.g., the identification of the additional spectrum emission mode is indicated and corresponds to an NS value.

In some examples, the intra-band contiguousCAadditionalSpectrumEmission parameter and the intra-band noncontiguousCAadditionalSpectrumEmission parameter may both be carried in the third configuration message configured for the mobile terminal 101 by the network device 102. The additional spectrum emission mode in the frequency band in a case of performing transmission using the intra-band contiguous carrier aggregation is determined by the mobile terminal 101 according to the identification of the additional spectrum emission mode indicated by the intra-band contiguousCAadditionalSpectrumEmission parameter. Alternatively, the additional spectrum emission mode in the frequency band in a case of performing transmission using the intra-band non-contiguous carrier aggregation is determined by the mobile terminal 101 according to the identification of the additional spectrum emission mode indicated by the intra-band noncontiguousCAadditionalSpectrumEmission parameter.

In some examples, the identification of the additional spectrum emission mode indicated by the intra-band contiguousCAadditionalSpectrumEmission parameter, the identification of the additional spectrum emission mode indicated by the intra-band noncontiguousCAadditionalSpectrumEmission parameter, and an identification of an additional spectrum emission mode indicated by an additionalSpectrumEmission parameter may all be represented by values in a range from 0 to 7.

In the example of the disclosure, the third configuration message for indicating an additional spectrum emission requirement for transmission using the CA may be configured for the mobile terminal 101 by the network device 102, so that after receiving the first configuration message for indicating the carrier aggregation type, the mobile terminal 101 may determine, according to the third configuration message, the additional spectrum emission requirement for transmission using the intra-band contiguous carrier aggregation or the intra-band non-contiguous carrier aggregation.

In the example of the disclosure, the network device 102 firstly sends the third configuration message to the mobile terminal 101 and then sends to the mobile terminal 101 the first configuration message for indicating the carrier aggregation type. In another example, the network device 102 may send to the mobile terminal 101 the first configuration message for indicating the carrier aggregation type and then send the third configuration message to the mobile terminal 101.

There is provided a method for receiving configuration information according to an example of the disclosure and shown in FIG. 6A. The method for receiving the configuration information is performed by a mobile terminal 101. The method for receiving the configuration information includes steps S601-1 and S602-1.

Step S601-1 includes receiving a third configuration message. The third configuration message includes a frequency band parameter and an intra-band contiguousCAadditionalSpectrumEmission parameter. In a case that the intra-band contiguousCAadditionalSpectrumEmission parameter indicates a default value, it is determined that an additional spectrum emission mode corresponding to a frequency band indicated by the frequency band parameter in a case of using intra-band contiguous carrier aggregation is a first default additional spectrum emission mode.

Step S602-1 includes receiving by the mobile terminal 101 a first configuration message for indicating a carrier aggregation type. The carrier aggregation type is intra-band contiguous carrier aggregation or intra-band non-contiguous carrier aggregation.

In some examples, in a case that the intra-band contiguousCAadditionalSpectrumEmission parameter in the third configuration message indicates a default value, it indicates that the network device 102 configures a value of the intra-band contiguousCAadditionalSpectrumEmission parameter as a default value, or, the network device 102 does not configure the value of the intra-band contiguousCAadditionalSpectrumEmission parameter.

In an example, a default value of the frequency band parameter in a case of the intra-band contiguous carrier aggregation is 0, and in conjunction with FIG. 7, a corresponding NS value is NS_01 in this case.

In the example of the disclosure, for the third configuration message configured by the network device 102, in a case that the value of the intra-band contiguousCAadditionalSpectrumEmission parameter in the third configuration message is a default value, the mobile terminal 101 may transmit a signal under the intra-band contiguous carrier aggregation and in the frequency band indicated by the frequency band parameter by adopting the first default additional spectrum emission mode.

An example of the disclosure provides a method for receiving configuration information shown in FIG. 6B. The method for receiving the configuration information is performed by a mobile terminal 101. The method for receiving the configuration information includes steps S601-2 and S602-2.

Step S601-2 includes receiving by the mobile terminal 101 a third configuration message. The third configuration message includes a frequency band parameter and an intra-band noncontiguousCAadditionalSpectrumEmission parameter. In a case that the intra-band noncontiguousCAadditionalSpectrumEmission parameter indicates a default value, it is determined that an additional spectrum emission mode corresponding to a frequency band indicated by the frequency band parameter in a case of using the intra-band non-contiguous carrier aggregation is a second default additional spectrum emission mode.

Step S602-2 includes receiving by the mobile terminal 101 a first configuration message for indicating a carrier aggregation type. The carrier aggregation type is intra-band contiguous carrier aggregation or intra-band non-contiguous carrier aggregation.

In some examples, in a case that the intra-band noncontiguousCAadditionalSpectrumEmission parameter in the third configuration message indicates a default value, it indicates that the network device 102 configures a value of the intra-band noncontiguousCAadditionalSpectrumEmission parameter as a default value, or, the network device 102 does not configure the value of the intra-band noncontiguousCAadditionalSpectrumEmission parameter.

In an example, a default value of the frequency band parameter in a case of the intra-band non-contiguous carrier aggregation is 0, and in conjunction with FIG. 8, a corresponding NS value is NS_01.

In the example of the disclosure, for the third configuration message configured by the network device 102, in a case that the value of the intra-band noncontiguousCAadditionalSpectrumEmission parameter in the third configuration message is a default value, the mobile terminal 101 may transmit a signal under the intra-band non-contiguous carrier aggregation and in the frequency band indicated by the frequency band parameter by adopting the second default additional spectrum emission mode.

An example of the disclosure provides a method for receiving configuration information shown in FIG. 6C. The method for receiving the configuration information is performed by a mobile terminal 101. The method for receiving the configuration information includes steps S601-3 and S602-3.

Step S601-3 includes receiving by the mobile terminal 101 a third configuration message. The third configuration message includes a frequency band parameter, an intra-band contiguousCAadditionalSpectrumEmission parameter, and an intra-band noncontiguousCAadditionalSpectrumEmission parameter. In a case that the intra-band contiguousCAadditionalSpectrumEmission parameter and the intra-band noncontiguousCAadditionalSpectrumEmission parameter both indicate a default value, it is determined that an additional spectrum emission mode corresponding to a frequency band indicated by the frequency band parameter in a case of using the intra-band contiguous carrier aggregation is a first default additional spectrum emission mode, and it is determined that an additional spectrum emission mode corresponding to a frequency band indicated by the frequency band parameter in a case of using the intra-band non-contiguous carrier aggregation is a second default additional spectrum emission mode.

Step S602-3 includes receiving by the mobile terminal 101 a first configuration message for indicating a carrier aggregation type. The carrier aggregation type is intra-band contiguous carrier aggregation or intra-band non-contiguous carrier aggregation.

In the example of the disclosure, in a case that the intra-band contiguousCAadditionalSpectrumEmission parameter and the intra-band noncontiguousCAadditionalSpectrumEmission parameter are both configured in the third configuration message and both correspond to a default value, the mobile terminal 101 may transmit a signal under the intra-band contiguous carrier aggregation and in the frequency band indicated by the frequency band parameter by adopting the first default additional spectrum emission mode, and transmit a signal under the intra-band non-contiguous carrier aggregation and in the frequency band indicated by the frequency band parameter by adopting the second default additional spectrum emission mode.

To further describe the implementations of the examples of the disclosure, examples are set forth below.

### Example 1

A mobile terminal 101 determines that a carrier aggregation type is intra-band contiguous carrier aggregation according to a first configuration message sent by a network device 102.

The mobile terminal 101, according to a second configuration message sent by the network device 102, determines that in the second configuration message, an identification of a frequency band indicated by a frequency band parameter corresponds to an n41 frequency band and an n48 frequency band, and an identification of an additional spectrum emission mode indicated by an additionalSpectrumEmission parameter corresponds to 0 and 1.

The mobile terminal 101 determines, according to the second configuration message, NS values corresponding to different frequency bands in the intra-band contiguous carrier aggregation. In conjunction with FIG. 7, in a case that the frequency band is the n41 frequency band and the identification of the additional spectrum emission mode is 0, it corresponds to NS_01; and in a case that the frequency band is the n48 frequency band and the identification of the additional spectrum emission mode is 1, it corresponds to NS_27.

The mobile terminal 101 may, according to requirements of the NS values, transmit a signal at power corresponding to NS_01 in the n41 frequency band of the intra-band contiguous carrier aggregation, and transmit a signal at power corresponding to NS_27 in the n48 frequency band of the intra-band contiguous carrier aggregation.

### Example 2

A mobile terminal 101 determines that a carrier aggregation type is intra-band contiguous carrier aggregation according to a first configuration message sent by a network device 102.

A second configuration message is not received by the mobile terminal 101 after receiving the first configuration message.

The mobile terminal 101 determines that an identification of an additional spectrum emission mode indicated by an additionalSpectrumEmission parameter under the intra-band contiguous carrier aggregation corresponds to 0. In conjunction with FIG. 7, the identification 0 corresponds to NS_01.

The mobile terminal 101 transmits, according to a requirement of an NS value, a signal at power corresponding to NS_01 in any frequency band involved in the intra-band contiguous carrier aggregation.

### Example 3

A mobile terminal 101 determines, according to a third configuration message sent by a network device 102, that the third configuration message contains an intra-band contiguousCAadditionalSpectrumEmission parameter, where an identification of a frequency band indicated by a frequency band parameter corresponds to an n41 frequency band, and an identification of an additional spectrum emission mode indicated by an additionalSpectrumEmission parameter indicates a default value (e.g., 0).

The mobile terminal 101 determines, according to a first configuration message sent by the network device 102, that a carrier aggregation type is intra-band contiguous carrier aggregation.

In conjunction with FIG. 7, the mobile terminal 101 determines that an NS value corresponding to a first default additional spectrum emission mode is NS_01.

The mobile terminal 101 transmits, according to a requirement of the NS value, a signal at power corresponding to NS_01 in the n41 frequency band in the intra-band contiguous carrier aggregation.

### Example 4

A mobile terminal 101 determines, according to a third configuration message sent by a network device 102, that the third configuration message contains an intra-band noncontiguousCAadditionalSpectrumEmission parameter, where an identification of a frequency band indicated by a frequency band parameter corresponds to an n41 frequency band, and an identification of an additional spectrum emission mode indicated by an additionalSpectrumEmission parameter indicates a default value (e.g., 0).

The mobile terminal 101 determines that a carrier aggregation type is intra-band non-contiguous carrier aggregation according to a first configuration message sent by the network device 102.

In conjunction with FIG. 8, the mobile terminal 101 determines that an NS value corresponding to a second default additional spectrum emission mode is NS_01.

The mobile terminal 101 transmits, according to a requirement of the NS value, a signal at power corresponding to NS_01 in the n41 frequency band in the intra-band non-contiguous carrier aggregation.

### Example 5

It is determined, according to a third configuration message sent by a network device 102, that the third configuration message includes an intra-band contiguousCAadditionalSpectrumEmission parameter and an intra-band noncontiguousCAadditionalSpectrumEmission parameter.

The intra-band noncontiguousCAadditionalSpectrumEmission parameter in the third configuration message is null. In the intra-band contiguousCAadditionalSpectrumEmission parameter, an identification of a frequency band indicated by a frequency band parameter corresponds to an n41 frequency band, and an identification of an additional spectrum emission mode indicated by an additionalSpectrumEmission parameter corresponds to 1.

The mobile terminal 101 determines that a carrier aggregation type is intra-band contiguous carrier aggregation according to a first configuration message sent by the network device 102.

The mobile terminal 101 determines, according to the third configuration message, an NS value corresponding to the frequency band in the intra-band contiguous carrier aggregation. In conjunction with FIG. 7, in a case that the frequency band is the n41 frequency band and the identification of the additional spectrum emission mode is 1, the NS value corresponds to NS_04.

The mobile terminal 101 may transmit, according to a requirement of the NS value, a signal at power corresponding to NS_04 in the n41 frequency band of the intra-band contiguous carrier aggregation.

### Example 6

In a transmission scenario utilizing a single carrier, a mobile terminal 101 transmits, in accordance with an additionalSpectrumEmission parameter and a frequency band parameter configured by a network device, a signal in a frequency band corresponding to the single carrier by adopting a requirement corresponding to the additionalSpectrumEmission parameter.

The mobile terminal 101 determines that a carrier aggregation type is intra-band contiguous carrier aggregation according to a first configuration message sent by the network device 102.

The mobile terminal 101, according to a second configuration message sent by the network device 102, determines that in the second configuration message, an identification of a frequency band indicated by the frequency band parameter corresponds to an n41 frequency band and an n48 frequency band, and an identification of an additional spectrum emission mode indicated by the additionalSpectrumEmission parameter corresponds to 0 and 1.

The mobile terminal 101 determines, according to the second configuration message, NS values corresponding to different frequency bands in the intra-band contiguous carrier aggregation. In conjunction with FIG. 7, in a case that the frequency band is the n41 frequency band and the identification of the additional spectrum emission mode is 0, the NS value corresponds to NS_01; and in a case that the frequency band is the n48 frequency band and the identification of the additional spectrum emission mode is 1, the NS value corresponds to NS_27.

The mobile terminal 101 may, according to requirements of the NS values, transmit a signal at power corresponding to NS_01 in the n41 frequency band of the intra-band contiguous carrier aggregation, and transmit a signal at power corresponding to NS_27 in the n48 frequency band of the intra-band contiguous carrier aggregation.

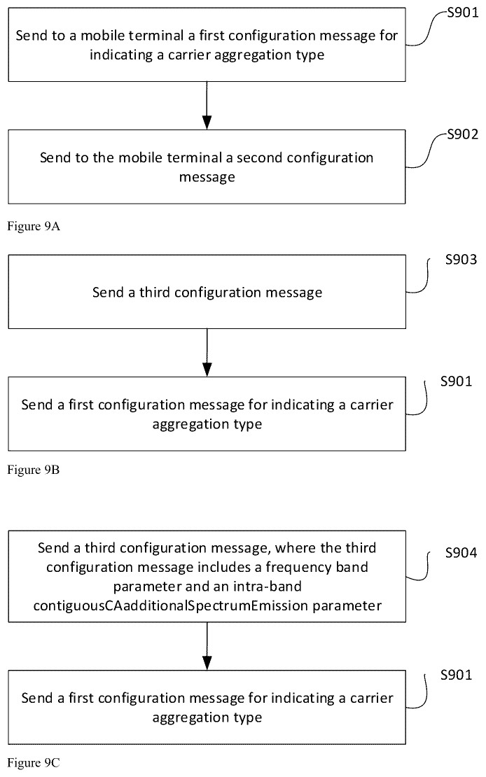

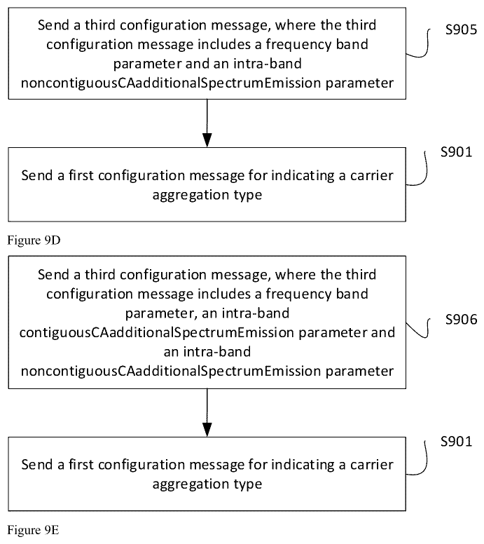

An example of the disclosure provides a method for sending configuration information. Referring to FIG. 9, FIG. 9 is a method for sending configuration information according to an example. The method for sending the configuration information is performed by a network device 102. As shown in FIG. 9, the method for sending the configuration information includes step S901.

In step S901, a first configuration message for indicating a carrier aggregation type is sent to a mobile terminal 101 by the network device 102. The carrier aggregation type is intra-band contiguous carrier aggregation or intra-band non-contiguous carrier aggregation.

In the example of the disclosure, the carrier aggregation type can be configured for the mobile terminal 101 by the network device 102, so that an additional spectrum emission mode in a scenario of carrier aggregation may be determined by the mobile terminal, and thus an additional spectrum emission requirement in the scenario of the carrier aggregation is met.

An example of the disclosure provides a method for sending configuration information. The method for sending the configuration information is performed by a network device 102. Referring to FIG. 9A, the method for sending the configuration information includes steps S901 and S902.

In step S901, a first configuration message for indicating a carrier aggregation type is sent to a mobile terminal 101 by the network device 102. The carrier aggregation type is intra-band contiguous carrier aggregation or intra-band non-contiguous carrier aggregation.

In step S902, a second configuration message is sent by the network device 102, where the second configuration message includes a frequency band parameter and an additionalSpectrumEmission parameter, the frequency band parameter is configured to indicate an identification of a frequency band, and the additionalSpectrumEmission parameter is configured to indicate an identification of an additional spectrum emission mode in the frequency band.

In the example of the disclosure, the network device 102 may not only configure an additionalSpectrumEmission parameter for a single carrier, but also may indicate, after sending the first configuration message, additionalSpectrumEmission parameters for the intra-band contiguous carrier aggregation or the intra-band non-contiguous carrier aggregation through the configured second configuration message.

An example of the disclosure provides a method for sending configuration information. The method for sending the configuration information is performed by a network device 102. Referring to FIG. 9B, the method for sending the configuration information includes steps S901 and S903.

In step S903, a third configuration message is sent. The third configuration message includes a frequency band parameter and further includes at least one of an intra-band contiguousCAadditionalSpectrumEmission parameter and an intra-band noncontiguousCAadditionalSpectrumEmission parameter. The frequency band parameter is configured to indicate an identification of a frequency band. The intra-band contiguousCAadditionalSpectrumEmission parameter is configured to indicate, for transmission using the intra-band contiguous carrier aggregation by the mobile terminal, an identification of an additional spectrum emission mode in the frequency band. The intra-band noncontiguousCAadditionalSpectrumEmission parameter is configured to indicate, for transmission using the intra-band non-contiguous carrier aggregation by the mobile terminal, an identification of an additional spectrum emission mode in the frequency band.

In step S901, a first configuration message for indicating a carrier aggregation type is sent to the mobile terminal 101 by the network device 102. The carrier aggregation type is the intra-band contiguous carrier aggregation or the intra-band non-contiguous carrier aggregation.

In the example of the disclosure, the third configuration message for indicating an additional spectrum emission requirement for transmission using the CA may be configured for the mobile terminal 101 by the network device 102, so that the mobile terminal 101 may directly determine, according to the third configuration message, the additional spectrum emission requirement for the transmission using the intra-band contiguous carrier aggregation and the intra-band non-contiguous carrier aggregation.

In another example, the third configuration message and then the first configuration message are sent to the mobile terminal 101 by the network device 102.

An example of the disclosure provides a method for sending configuration information. The method for sending the configuration information is performed by a network device 102. Referring to FIG. 9C, the method for sending the configuration information includes steps S901 and S904.

In step S904, a third configuration message is sent by the network device 102. The third configuration message includes a frequency band parameter and an intra-band contiguousCAadditionalSpectrumEmission parameter. The intra-band contiguousCAadditionalSpectrumEmission parameter indicates a default value.

In step S901, a first configuration message for indicating a carrier aggregation type is sent to a mobile terminal 101 by the network device 102. The carrier aggregation type is intra-band contiguous carrier aggregation or intra-band non-contiguous carrier aggregation.

In the example of the disclosure, the third configuration message for indicating an additional spectrum emission requirement for the intra-band contiguous carrier aggregation may be configured for the mobile terminal 101 by the network device 102, so that the mobile terminal 101 may directly determine, according to the third configuration message, the additional spectrum emission requirement for transmission using the intra-band contiguous carrier aggregation.

In another example, the third configuration message and then the first configuration message are sent to the mobile terminal 101 by the network device 102.

An example of the disclosure provides a method for sending configuration information. The method for sending the configuration information is performed by a network device 102. Referring to FIG. 9D, the method for sending the configuration information includes steps S901 and S905.

In step S905, a third configuration message is sent by the network device 102. The third configuration message includes a frequency band parameter and an intra-band noncontiguousCAadditionalSpectrumEmission parameter. The intra-band noncontiguousCAadditionalSpectrumEmission parameter indicates a default value.

In step S901, a first configuration message for indicating a carrier aggregation type is sent to a mobile terminal 101 by the network device 102. The carrier aggregation type is intra-band contiguous carrier aggregation or intra-band non-contiguous carrier aggregation.

In the example of the disclosure, the third configuration message for indicating an additional spectrum emission requirement for the intra-band non-contiguous carrier aggregation may be configured for the mobile terminal 101 by the network device 102, so that the mobile terminal 101 may directly determine, according to the third configuration message, the additional spectrum emission requirement for transmission using the intra-band non-contiguous carrier aggregation.

In another example, the third configuration message and then the first configuration message are sent to the mobile terminal 101 by the network device 102.

An example of the disclosure provides a method for sending configuration information. The method for sending the configuration information is performed by a network device 102. Referring to FIG. 9E, the method for sending the configuration information includes steps S901 and S906.

In step S906, a third configuration message is sent by the network device 102. The third configuration message includes a frequency band parameter, an intra-band contiguousCAadditionalSpectrumEmission parameter and an intra-band noncontiguousCAadditionalSpectrumEmission parameter. The intra-band contiguousCAadditionalSpectrumEmission parameter and the intra-band noncontiguousCAadditionalSpectrumEmission parameter both indicate a default value.

In step S901, a first configuration message for indicating a carrier aggregation type is sent to a mobile terminal 101 by the network device 102. The carrier aggregation type is intra-band contiguous carrier aggregation or intra-band non-contiguous carrier aggregation.

In the example of the disclosure, in a case that the intra-band contiguousCAadditionalSpectrumEmission parameter and the intra-band noncontiguousCAadditionalSpectrumEmission parameter are both configured in the third configuration message by the network device 102 and both correspond to a default value, the mobile terminal 101 may transmit a signal under the intra-band contiguous carrier aggregation and in a frequency band indicated by the frequency band parameter by adopting a first default additional spectrum emission mode, and transmit a signal under the intra-band non-contiguous carrier aggregation and in a frequency band indicated by the frequency band parameter by adopting a second default additional spectrum emission mode.

In another example, the third configuration message and then the first configuration message are sent to the mobile terminal 101 by the network device 102.

Based on the same idea as the method examples, an example of the disclosure further provides an apparatus for receiving configuration information, which may have functions of the mobile terminal 101 in the method examples and may be configured to perform the steps performed by the mobile terminal 101 provided by the method examples. The functions may be implemented by hardware or by software or by hardware executing corresponding software. The hardware or software includes one or more modules corresponding to the functions.

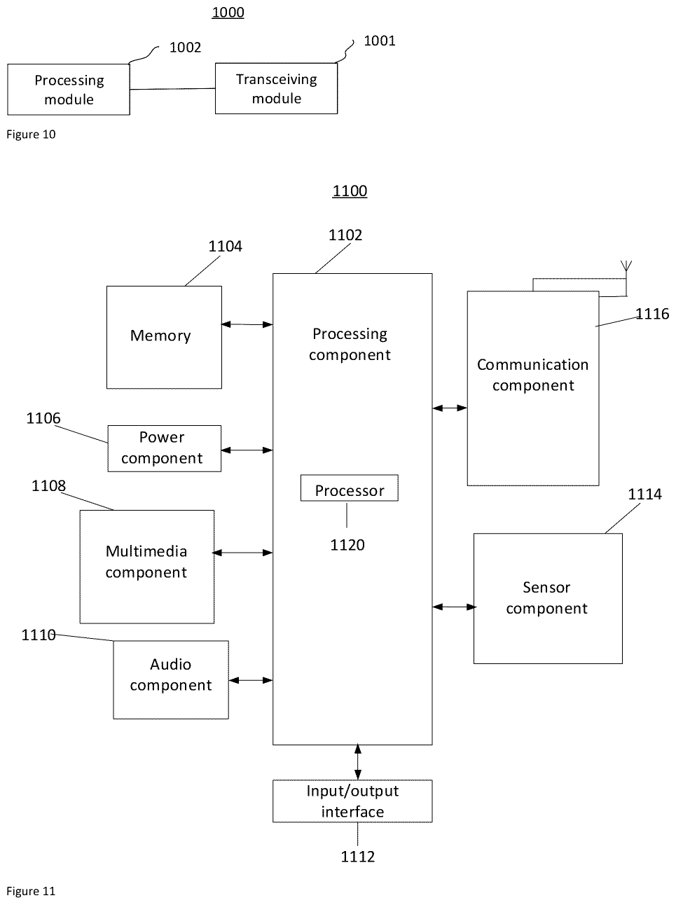

In an example, an apparatus 1000 as shown in FIG. 10 may serve as the mobile terminal 101 involved in the method examples, and perform the steps performed by the mobile terminal 101 in the method examples. As shown in FIG. 10, the apparatus 1000 may include a transceiving module 1001 and a processing module 1002 coupled to each other. The transceiving module 1001 may be configured to support a communication apparatus for a communication. The processing module 1002 may be configured for the communication apparatus to perform a processing operation such as generating information/message that needs to be sent, or processing a received signal to obtain information/message.

When performing the steps implemented by the mobile terminal 101, the transceiving module 1001 is configured to receive a first configuration message for indicating a carrier aggregation type. The carrier aggregation type is intra-band contiguous carrier aggregation or intra-band non-contiguous carrier aggregation. The processing module 1002 is configured to determine an additional spectrum emission mode corresponding to the carrier aggregation type.

In a case that the apparatus for receiving the configuration information is the mobile terminal 101, its structure may be as shown in FIG. 11. The apparatus 1100 may be a mobile phone, a computer, a digital broadcasting terminal, a messaging device, a game console, a tablet device, a medical device, a fitness device, a personal digital assistant, etc.

Referring to FIG. 11, the apparatus 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls the overall operation of the apparatus 1100, such as operations associated with display, a telephone call, data communication, a camera operation, and a recording operation. The processing component 1102 may include one or more processors 1120 to execute instructions to complete all or part of the steps of the methods. In addition, the processing component 1102 may include one or more modules to facilitate interaction between the processing component 1102 and other components. For example, the processing component 1102 may include a multimedia module to facilitate interaction between the multimedia component 1108 and the processing component 1102.

The memory 1104 is configured to store various types of data to support operations at the apparatus 1100. Examples of these data include instructions for any application or method operating on the apparatus 1100, contact data, phonebook data, messages, pictures, videos, etc. The memory 1104 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 1106 provides power for various components of the apparatus 1100. The power component 1106 may include a power management system, one or more power sources and other components associated with generating, managing and distributing power for the apparatus 1100.

The multimedia component 1108 includes a screen providing an output interface between the apparatus 1100 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense a touch, sliding and gestures on the touch panel. The touch sensor can not only sense the boundary of the touch or sliding operation, but also detect the duration and pressure related to the touch or sliding operation. In some examples, the multimedia component 1108 includes a front camera and/or a rear camera. When the apparatus 1100 is in an operation mode, such as a shooting mode or a video mode, the front camera and/or the rear camera can receive external multimedia data. Each of the front camera and the rear camera may be a fixed optical lens system or have a focal length and optical zoom capability.

The audio component 1110 is configured to output and/or input audio signals. For example, the audio component 1110 includes a microphone (MIC) configured to receive an external audio signal when the apparatus 1100 is in an operation mode, such as a call mode, a recording mode, and a speech recognition mode. The received audio signal may be further stored in the memory 1104 or sent via the communication component 1116. In some examples, the audio component 1110 also includes a speaker for outputting an audio signal.

The I/O interface 1112 provides an interface between the processing component 1102 and a peripheral interface module which may be a keyboard, a click wheel, a button, etc. These buttons may include but are not limited to a home button, a volume button, a start button and a lock button.

The sensor component 1114 includes one or more sensors for providing state evaluation of various aspects for the apparatus 1100. For example, the sensor component 1114 can detect an on/off state of the apparatus 1100 and the relative positioning of components, for example, the component is a display and a keypad of the apparatus 1100. The sensor component 1114 can also detect the change of the position of the apparatus 1100 or one component of the apparatus 1100, the presence or absence of user contact with the apparatus 1100, the azimuth or acceleration/deceleration of the apparatus 1100, and temperature change of the apparatus 1100. The sensor component 1114 may include a proximity sensor configured to detect the presence of nearby objects without any physical contact. The sensor component 1114 may further include an optical sensor, such as a CMOS or CCD image sensor, for use in imaging applications. In some examples, the sensor component 1114 may further include an acceleration sensor, a gyroscope sensor, a magnetic sensor, a pressure sensor, or a temperature sensor.

The communication component 1116 is configured to facilitate wired or wireless communication between the apparatus 1100 and other devices. The apparatus 1100 may access a wireless network based on a communication standard, such as WiFi, 2G or 3G, or their combination. In an example, the communication component 1116 receives a broadcast signal or broadcast-related information from an external broadcast management system via a broadcast channel. In an example, the communication component 1116 further includes a near field communication (NFC) module to facilitate short-range communication. For example, the NFC module may be implemented based on a radio frequency identification (RFID) technology, an infrared data association (IrDA) technology, an ultra wideband (UWB) technology, a Bluetooth (BT) technology and other technologies.

In an example, the apparatus 1100 may be implemented by one or more of application-specific integrated circuits (ASICs), digital signal processors (DSPs), digital signal processing devices (DSPDs), programmable logic devices (PLDs), field programmable gate arrays (FPGAs), controllers, micro controller units, microprocessors, or other electronic elements for performing the method.

In an example, a non-transitory computer-readable storage medium including instructions, such as the memory 1104 including instructions, which may be executed by the processor 1120 of the apparatus 1100 to implement the method, is further provided. For example, the non-transitory computer-readable storage medium may be an ROM, a random access memory (RAM), a CD-ROM, a magnetic tape, a floppy disk, an optical data storage device, etc.

Based on the same idea as the method examples, an example of the disclosure further provides an apparatus for sending configuration information, which may have functions of the network device 102 in the method examples and may be configured to perform the steps performed by the network device 102 provided by the method examples. The functions may be implemented by hardware or by software or by hardware executing corresponding software. The hardware or software includes one or more modules corresponding to the functions.

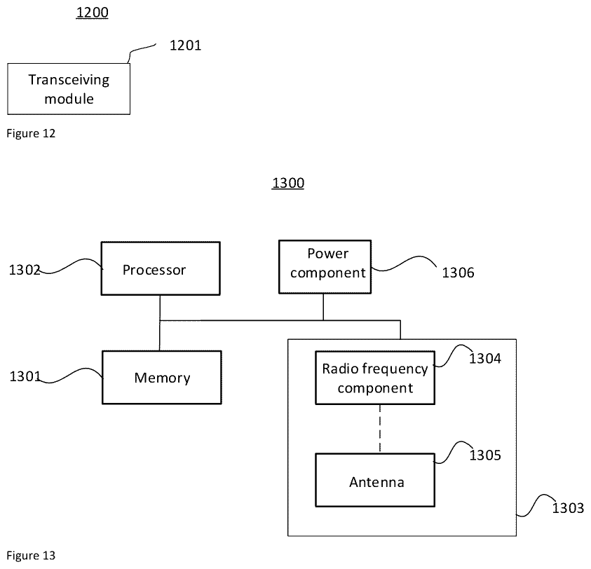

In an example, a communication apparatus 1200 as shown in FIG. 12 may serve as the network device 102 involved in the method examples, and perform the steps performed by the network device 102 in the method examples. As shown in FIG. 12, the communication apparatus 1200 may include a transceiving module 1201. The transceiving module 1201 may be configured to support the communication apparatus 1200 for a communication, and may have a wireless communication function, such as being capable of communicating wirelessly with other communication apparatus via new radio.

When performing the steps implemented by the network device 102, the transceiving module 1201 is configured to send to a mobile terminal 101 a first configuration message for indicating a carrier aggregation type. The carrier aggregation type is intra-band contiguous carrier aggregation or intra-band non-contiguous carrier aggregation.

In a case that this communication apparatus is the network device 102, its structure may be as shown in FIG. 13. A structure of the communication apparatus is illustrated using a base station as an example. As shown in FIG. 13, the apparatus 1300 includes a memory 1301, a processor 1302, a transceiving component 1303, and a power component 1306. The memory 1301 is coupled to the processor 1302 and may be configured to store programs and data necessary for the communication apparatus 1300 to implement various functions. The processor 1302 is configured to support the communication apparatus 1300 in executing corresponding functions in the methods, and the functions may be implemented by calling a program stored in the memory 1301. The transceiving component 1303 may be a wireless transceiver that may be configured to support the communication apparatus 1300 in receiving signaling and/or data, and sending signaling and/or data via a new radio. The transceiving component 1303 may also be referred to as a transceiving unit or a communication unit, and may include a radio frequency component 1304 and one or more antennas 1305. The radio frequency component 1304 may be a remote radio unit (RRU), which may be configured for transmission of a radio frequency signal and a conversion of the radio frequency signal and a baseband signal. The one or more antennas 1305 may be configured to perform radiation and reception of the radio frequency signal.

When the communication apparatus 1300 needs to send data, the processor 1302 may performing baseband processing on the data to be sent and output the baseband signal to the radio frequency unit, and the radio frequency unit performs radio frequency processing on the baseband signal and sends the radio frequency signal in a form of an electromagnetic wave through the antenna. When there is data sent to the communication apparatus 1300, the radio frequency unit receives radio frequency signal through the antenna, converts the radio frequency signal into baseband signal, and outputs the baseband signal to the processor 1302, and the processor 1302 converts the baseband signal into data and processes the data.

Additional non-limiting embodiments of the disclosure include the following.

In a first aspect, there is provided a method for receiving configuration information. The method for receiving the configuration information is performed by a mobile terminal, and includes: receiving a first configuration message for indicating a carrier aggregation type, where the carrier aggregation type is intra-band contiguous carrier aggregation or intra-band non-contiguous carrier aggregation; and determining an additional spectrum emission mode corresponding to the carrier aggregation type.

In the method of the disclosure, after determining the carrier aggregation type according to the first configuration information, the mobile terminal may determine the additional spectrum emission mode corresponding to the carrier aggregation type. Thus, the mobile terminal can determine an additional spectrum emission requirement which needs to be met in a corresponding frequency band in a scenario of carrier aggregation, so as to perform signal transmission based on the additional spectrum emission mode. In this way, not only an additional spectrum emission requirement under a single carrier, but also an additional spectrum emission requirement in the scenario of the carrier aggregation can be met.

In some examples, the method further includes: receiving a second configuration message, where the second configuration message includes a frequency band parameter and an additionalSpectrumEmission parameter, the frequency band parameter is configured to indicate an identification of a frequency band, and the additionalSpectrumEmission parameter is configured to indicate an identification of an additional spectrum emission mode in the frequency band.

In some examples, determining the additional spectrum emission mode corresponding to the carrier aggregation type includes: determining that the additional spectrum emission mode in the frequency band corresponding to the carrier aggregation type is the additional spectrum emission mode indicated by the additionalSpectrumEmission parameter.

In some examples, the method further includes: determining that an identification of an additional spectrum emission mode corresponding to a set frequency band is a default value in a case that a second configuration message is not received after receiving the first configuration message; where the second configuration message includes a frequency band parameter and an additionalSpectrumEmission parameter, the frequency band parameter is configured to indicate an identification of a frequency band, and the additionalSpectrumEmission parameter is configured to indicate an identification of an additional spectrum emission mode corresponding to the frequency band.

In some examples, the method further includes: receiving a third configuration message, where the third configuration message includes a frequency band parameter and further includes at least one of an intra-band contiguousCAadditionalSpectrumEmission parameter and an intra-band noncontiguousCAadditionalSpectrumEmission parameter, the frequency band parameter is configured to indicate an identification of a frequency band, the intra-band contiguousCAadditionalSpectrumEmission parameter is configured to indicate, for transmission using the intra-band contiguous carrier aggregation by the mobile terminal, an identification of an additional spectrum emission mode in the frequency band, and the intra-band noncontiguousCAadditionalSpectrumEmission parameter is configured to indicate, for transmission using the intra-band non-contiguous carrier aggregation by the mobile terminal, an identification of an additional spectrum emission mode in the frequency band.

In some examples, the method further includes: receiving a third configuration message. The third configuration message includes a frequency band parameter and an intra-band contiguousCAadditionalSpectrumEmission parameter. In a case that the intra-band contiguousCAadditionalSpectrumEmission parameter indicates a default value, it is determined that an additional spectrum emission mode corresponding to a frequency band indicated by the frequency band parameter in a case of using the intra-band contiguous carrier aggregation is a first default additional spectrum emission mode.

In some examples, the method further includes: receiving a third configuration message. The third configuration message includes a frequency band parameter and an intra-band noncontiguousCAadditionalSpectrumEmission parameter. In a case that the intra-band noncontiguousCAadditionalSpectrumEmission parameter indicates a default value, it is determined that an additional spectrum emission mode corresponding to a frequency band indicated by the frequency band parameter in a case of using the intra-band non-contiguous carrier aggregation is a second default additional spectrum emission mode.

In some examples, the method further includes: receiving a third configuration message. The third configuration message includes a frequency band parameter, an intra-band contiguousCAadditionalSpectrumEmission parameter, and an intra-band noncontiguousCAadditionalSpectrumEmission parameter. In a case that the intra-band contiguousCAadditionalSpectrumEmission parameter and the intra-band noncontiguousCAadditionalSpectrumEmission parameter both indicate a default value, it is determined that an additional spectrum emission mode corresponding to a frequency band indicated by the frequency band parameter in a case of using the intra-band contiguous carrier aggregation is a first default additional spectrum emission mode, and it is determined that an additional spectrum emission mode corresponding to a frequency band indicated by the frequency band parameter in a case of using the intra-band non-contiguous carrier aggregation is a second default additional spectrum emission mode.

In a second aspect, there is provided a method for sending configuration information. The method for sending configuration information is performed by a network device, and includes: sending, to a mobile terminal, a first configuration message for indicating a carrier aggregation type. The carrier aggregation type is intra-band contiguous carrier aggregation or intra-band non-contiguous carrier aggregation.

In the method of the disclosure, the carrier aggregation type may be configured for the mobile terminal by the network device, so that an additional spectrum emission mode in a scenario of carrier aggregation may be determined by the mobile terminal, and thus an additional spectrum emission requirement in the scenario of the carrier aggregation is met.

In some examples, the method further includes: sending a second configuration message, where the second configuration message includes a frequency band parameter and an additionalSpectrumEmission parameter, the frequency band parameter is configured to indicate an identification of a frequency band, and the additionalSpectrumEmission parameter is configured to indicate an identification of an additional spectrum emission mode in the frequency band.

In some examples, the method further includes: sending a third configuration message, where the third configuration message includes a frequency band parameter and further includes at least one of an intra-band contiguousCAadditionalSpectrumEmission parameter and an intra-band noncontiguousCAadditionalSpectrumEmission parameter, the frequency band parameter is configured to indicate an identification of a frequency band, the intra-band contiguousCAadditionalSpectrumEmission parameter is configured to indicate, for transmission using the intra-band contiguous carrier aggregation by the mobile terminal, an identification of an additional spectrum emission mode in the frequency band, and the intra-band noncontiguousCAadditionalSpectrumEmission parameter is configured to indicate, for transmission using the intra-band non-contiguous carrier aggregation by the mobile terminal, an identification of an additional spectrum emission mode in the frequency band.

In some examples, the method further includes: sending a third configuration message. The third configuration message includes a frequency band parameter and an intra-band contiguousCAadditionalSpectrumEmission parameter, and the intra-band contiguousCAadditionalSpectrumEmission parameter indicates a default value.

In some examples, the method further includes: sending a third configuration message. The third configuration message includes a frequency band parameter and an intra-band noncontiguousCAadditionalSpectrumEmission parameter, and the intra-band noncontiguousCAadditionalSpectrumEmission parameter indicates a default value.

In some examples, the method further includes: sending a third configuration message. The third configuration message includes a frequency band parameter, an intra-band contiguousCAadditionalSpectrumEmission parameter, and an intra-band noncontiguousCAadditionalSpectrumEmission parameter, and the intra-band contiguousCAadditionalSpectrumEmission parameter and the intra-band noncontiguousCAadditionalSpectrumEmission parameter both indicate a default value.

In a third aspect, there is provided an apparatus for receiving configuration information. The apparatus for receiving the configuration information may be configured to perform steps performed by a mobile terminal in the first aspect or in any of designs of the first aspect. Each function in each of the methods may be implemented by the mobile terminal in a form of a hardware structure, a software module, or a hardware structure plus a software module.

In a case that the apparatus in the third aspect is implemented by means of the software module, the apparatus may include a transceiving module and a processing module coupled to each other, where the transceiving module may be configured to support a communication apparatus for a communication, and the processing module may be configured to support the communication apparatus for executing a processing operation such as generating information/message that needs to be sent, or processing a received signal to obtain information/message.

When executing the steps in the first aspect, the transceiving module is configured to receive a first configuration message configured to indicate a carrier aggregation type, where the carrier aggregation type is intra-band contiguous carrier aggregation or intra-band non-contiguous carrier aggregation; and the processing module is configured to determine an additional spectrum emission mode corresponding to the carrier aggregation type.

In a fourth aspect, there is provided an apparatus for sending configuration information. The apparatus for sending the configuration information may be configured to execute steps executed by a network device in the second aspect or in any of designs of the second aspect. Each function in each of the methods may be implemented by the network device in a form of a hardware structure, a software module, or a hardware structure plus a software module.

In a case that the apparatus in the fourth aspect is implemented by means of the software module, the apparatus may include a transceiving module, where the transceiving module may be configured to support a communication apparatus for a communication.

When executing the steps in the second aspect, the transceiving module is configured to send to a mobile terminal a first configuration message for indicating a carrier aggregation type. The carrier aggregation type is intra-band contiguous carrier aggregation or intra-band non-contiguous carrier aggregation.

In a fifth aspect, there is provided an electronic device, including a processor and a memory. The memory is configured to store a computer program. The processor is configured to execute the computer program to implement the first aspect or any of designs of the first aspect.

In a sixth aspect, there is provided an electronic device, including a processor and a memory. The memory is configured to store a computer program. The processor is configured to execute the computer program to implement the second aspect or any of designs of the second aspect.

In a seventh aspect, there is provided a non-transitory computer readable storage medium. An instruction (or called a computer program or a program) is stored in the non-transitory computer readable storage medium, and the instruction, when being called and executed on a computer, causes the computer to execute the first aspect or any of designs of the first aspect.

In an eighth aspect, there is provided a non-transitory computer readable storage medium. An instruction (or called a computer program or a program) is stored in the non-transitory computer readable storage medium, and the instruction, when being called and executed on a computer, causes the computer to execute the second aspect or any of designs of the second aspect.

Other implementations of the examples of the disclosure will be apparent to those skilled in the art from consideration of the specification and practice of the disclosure disclosed here. The disclosure is intended to cover any variations, uses, or adaptations of the examples of the disclosure that follow the general principles of the examples of the disclosure and include common knowledge or customary technical means in the technical field not disclosed in the disclosure. The specification and examples are considered as examples, and the true scope and spirit of the examples of the disclosure are indicated by the following claims.

It is to be understood that the examples of the disclosure are not limited to the exact construction that has been described and illustrated in the accompanying drawings, and that various modifications and changes may be made without departing from its scope. The scopes of the examples of the disclosure are limited by the appended claims.

### INDUSTRIAL APPLICABILITY

In the examples of the disclosure, a carrier aggregation type can be configured for a mobile terminal by a network device and, and after obtaining the carrier aggregation type, the mobile terminal may determine an additional spectrum emission mode corresponding to the carrier aggregation type. Thus, the mobile terminal can determine an additional spectrum emission requirement which needs to be met in a corresponding frequency band in a scenario of carrier aggregation, so as to perform signal transmission on the basis of the additional spectrum emission mode. In this way, not only an additional spectrum emission requirement under a single carrier, but also the additional spectrum emission requirement in the scenario of the carrier aggregation can be met.

1. A method for receiving configuration information, performed by a mobile terminal, comprising:
receiving a first configuration message for indicating a carrier aggregation type, wherein the carrier aggregation type is intra-band contiguous carrier aggregation or intra-band non-contiguous carrier aggregation; and
determining an additional spectrum emission mode corresponding to the carrier aggregation type.

2. The method according to claim 1, further comprising:
receiving a second configuration message, wherein the second configuration message comprises a frequency band parameter and an additionalSpectrumEmission parameter, the frequency band parameter is configured to indicate an identification of a frequency band, and the additionalSpectrumEmission parameter is configured to indicate an identification of an additional spectrum emission mode in the frequency band.

3. The method according to claim 2, wherein determining the additional spectrum emission mode corresponding to the carrier aggregation type comprises:
determining that the additional spectrum emission mode in the frequency band corresponding to the carrier aggregation type is an additional spectrum emission mode indicated by the additionalSpectrumEmission parameter.

4. The method according to claim 1, further comprising:
a second configuration message is not received after receiving the first configuration message, and it is determined that an identification of an additional spectrum emission mode corresponding to a set frequency band is a default value,
wherein the second configuration message comprises a frequency band parameter and an additionalSpectrumEmission parameter, the frequency band parameter is configured to indicate an identification of a frequency band, and the additionalSpectrumEmission parameter is configured to indicate an identification of an additional spectrum emission mode corresponding to the frequency band.

5. The method according to claim 1, further comprising:
receiving a third configuration message, wherein the third configuration message comprises a frequency band parameter and further comprises at least one of an intra-band contiguousCAadditionalSpectrumEmission parameter and an intra-band noncontiguousCAadditionalSpectrumEmission parameter, the frequency band parameter is configured to indicate an identification of a frequency band, the intra-band contiguousCAadditionalSpectrumEmission parameter is configured to indicate, for transmission using the intra-band contiguous carrier aggregation by the mobile terminal, an identification of an additional spectrum emission mode in the frequency band, and the intra-band noncontiguousCAadditionalSpectrumEmission parameter is configured to indicate, for transmission using the intra-band non-contiguous carrier aggregation by the mobile terminal, an identification of an additional spectrum emission mode in the frequency band.

6. The method according to claim 1, further comprising:
receiving a third configuration message, wherein the third configuration message comprises a frequency band parameter and an intra-band contiguousCAadditionalSpectrumEmission parameter, and it is determined, in a case that the intra-band contiguousCAadditionalSpectrumEmission parameter indicates a default value, that an additional spectrum emission mode corresponding to a frequency band indicated by the frequency band parameter in a case of using the intra-band contiguous carrier aggregation is a first default additional spectrum emission mode.

7. The method according to claim 1, further comprising:
receiving a third configuration message, wherein the third configuration message comprises a frequency band parameter and an intra-band noncontiguousCAadditionalSpectrumEmission parameter, and it is determined, in a case that the intra-band noncontiguousCAadditionalSpectrumEmission parameter indicates a default value, that an additional spectrum emission mode corresponding to a frequency band indicated by the frequency band parameter in a case of using the intra-band non-contiguous carrier aggregation is a second default additional spectrum emission mode.

8. The method according to claim 1, further comprising:
receiving a third configuration message, wherein the third configuration message comprises a frequency band parameter, an intra-band contiguousCAadditionalSpectrumEmission parameter and an intra-band noncontiguousCAadditionalSpectrumEmission parameter, and in a case that the intra-band contiguousCAadditionalSpectrumEmission parameter and the intra-band noncontiguousCAadditionalSpectrumEmission parameter both indicate a default value, it is determined that an additional spectrum emission mode corresponding to a frequency band indicated by the frequency band parameter in a case of using the intra-band contiguous carrier aggregation is a first default additional spectrum emission mode and it is determined that an additional spectrum emission mode corresponding to a frequency band indicated by the frequency band parameter in a case of using the intra-band non-contiguous carrier aggregation is a second default additional spectrum emission mode.

9. A method for sending configuration information, performed by a network device, comprising:
sending to a mobile terminal a first configuration message for indicating a carrier aggregation type, wherein the carrier aggregation type is intra-band contiguous carrier aggregation or intra-band non-contiguous carrier aggregation.

10. The method according to claim 9, further comprising:
sending a second configuration message, wherein the second configuration message comprises a frequency band parameter and an additionalSpectrumEmission parameter, the frequency band parameter is configured to indicate an identification of a frequency band, and the additionalSpectrumEmission parameter is configured to indicate an identification of an additional spectrum emission mode in the frequency band.

11. The method according to claim 9, further comprising:
sending a third configuration message, wherein the third configuration message comprises a frequency band parameter and further comprises at least one of an intra-band contiguousCAadditionalSpectrumEmission parameter and an intra-band noncontiguousCAadditionalSpectrumEmission parameter, the frequency band parameter is configured to indicate an identification of a frequency band, the intra-band contiguousCAadditionalSpectrumEmission parameter is configured to indicate, for transmission using the intra-band contiguous carrier aggregation by the mobile terminal, an identification of an additional spectrum emission mode in the frequency band, and the intra-band noncontiguousCAadditionalSpectrumEmission parameter is configured to indicate, for transmission using the intra-band non-contiguous carrier aggregation by the mobile terminal, an identification of an additional spectrum emission mode in the frequency band.

12. The method according to claim 9, further comprising:
sending a third configuration message, wherein the third configuration message comprises a frequency band parameter and an intra-band contiguousCAadditionalSpectrumEmission parameter, and the intra-band contiguousCAadditionalSpectrumEmission parameter indicates a default value.

13. The method according to claim 9, further comprising:
sending a third configuration message, wherein the third configuration message comprises a frequency band parameter and an intra-band noncontiguousCAadditionalSpectrumEmission parameter, and the intra-band noncontiguousCAadditionalSpectrumEmission parameter indicates a default value.

14. The method according to claim 9, further comprising:
sending a third configuration message, wherein the third configuration message comprises a frequency band parameter, an intra-band contiguousCAadditionalSpectrumEmission parameter and an intra-band noncontiguousCAadditionalSpectrumEmission parameter, and the intra-band contiguousCAadditionalSpectrumEmission parameter and the intra-band noncontiguousCAadditionalSpectrumEmission parameter both indicate a default value.

15.-16. (canceled)

17. An electronic device, comprising a processor and a memory, wherein
the memory is configured to store a computer program; and
the processor is configured to execute the computer program to:
receive a first configuration message for indicating a carrier aggregation type, wherein the carrier aggregation type is intra-band contiguous carrier aggregation or intra-band non-contiguous carrier aggregation; and
determine an additional spectrum emission mode corresponding to the carrier aggregation type.

18. An electronic device, comprising a processor and a memory, wherein
the memory is configured to store a computer program; and
the processor is configured to execute the computer program to implement the method according to claim 9.

19. A non-transitory computer readable storage medium, wherein an instruction is stored in the non-transitory computer readable storage medium, and the instruction, when being called and executed on a computer, causes the computer to execute the method according to claim 1.

20. A non-transitory computer readable storage medium, wherein an instruction is stored in the non-transitory computer readable storage medium, and the instruction, when being called and executed on a computer, cause the computer to execute the method according to claim 9.
